(19) United States
(12) Patent Application Publication
(10) Pub. No.: US 2005/0206821 A1
(43) Pub. Date: Sep. 22, 2005

(54) [PIXEL STRUCTURE]

(76) Inventor: Han-Chung Lai, Taoyuan Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,306

(22) Filed: Apr. 28, 2004

(30) Foreign Application Priority Data
Mar. 18, 2004 (TW) 93107215

(51) Int. Cl. G02F 1/1343

(52) U.S. Cl. 349/139; 348/294

(57) ABSTRACT

A pixel structure suitable for disposing over a substrate is provided. The pixel structure includes a dielectric layer disposed between a scan line (data line) and a redundant scan line (redundant data line). At least three contact holes are formed in the dielectric layer through which the scan line (data line) is electrically connected with the redundant scan line (redundant data line). Therefore, even when some of the contact holes are not successfully formed, the signal may be transmitted via the redundant scan line (redundant data line).

### CROSS REFERENCE TO RELATED APPLICATIONS

This application claims the priority benefit of Taiwan application serial no. 93107215, filed Mar. 18, 2004.

### BACKGROUND OF INVENTION

1. Field of the Invention

The present invention generally relates to a pixel structure. More particularly, the present invention relates to a pixel structure that can transmit signal via the redundant scan line (redundant data line) even though some of the contact holes are not formed.

2. Description of Related Art

In recent years, since the semiconductor process and the display component have been developed drastically, the size and the weight of the display device are minimized and can be used for a portable electronic device. Conventionally, the display device is generally made of a cathode ray tube (CRT). However, the conventional CRT has the disadvantages of large size and high power consumption. Accordingly, a new generation flat panel display device combining the opto-electronic technology and semiconductor manufacturing technology, such as the liquid crystal display (LCD) device or the light emitting diode (LED) device is being developed.

The major component of the LCD device includes an active component array substrate, a color filter array substrate and a liquid crystal layer. The active component array substrate is constructed by a plurality of arrays of pixel units. The pixel units include a pair of pixel electrodes and an active component disposed between the pixel electrodes. The active component is used as the switching component of the liquid crystal unit. A specific pixel in the pixel unit is selected by selecting the corresponding scan line and data line, and by applying an applicable operation voltage to the specific pixel, the corresponding pixel data is displayed.

It is noted that, in the conventional technology, a redundant line is used to prevent the fault of signal transmission due to the open circuit of the scan line or the data line. Therefore, when the scan line or the data line is open, the signal may still be transmitted by the redundant line electrically connected to the scan line or the data.

FIG. 1 is a top view schematically illustrating a conventional pixel structure with a redundant line. FIG. 2 is a lateral cross-sectional view taken along the line A-A of FIG. 1. FIG. 3 is a lateral cross-sectional view according to line B-B of FIG. 1. Referring to FIG. 1, FIG. 2 and FIG. 3, the conventional pixel structure 100 is disposed on a substrate 10. The pixel structure 100 includes a scan line 110, a redundant scan line 120, a dielectric layer 130, a data line 140, a redundant data line 150, an active component 160 and a pixel electrode 170.

The scan line 110 and the data line 140 are disposed over the substrate 10, the redundant scan line 120 is disposed over the scan line 110, and the redundant data line 150 is disposed under the data line 140. The dielectric layer 130 is disposed between the scan line 110 and the redundant scan line 120, and between the data line 140 and the redundant data line 150. Two first contact holes 132 are disposed over the dielectric layer 130 between the scan line 110 and the redundant scan line 120 to electrically connect the scan line 110 and the redundant scan line 120. Two second contact holes 134 are disposed in the dielectric layer 130 between the data line 140 and the redundant data line 150 to electrically connect the data line 140 and the redundant data line 150.

The active component may be composed of a thin film transistor (TFT). The active component is disposed adjacent to the intersection of the scan line 110 and the data line 140. The pixel electrode 170 is electrically connected to the active component 160. The active component 160 is controlled by the scan line 110 to write the image signal transmitted by the data line 140 to the pixel electrode 170.

Accordingly, the scan line 110 and the data line 140 are electrically connected to the corresponding redundant scan line 120 and the redundant data line 150 through the two first contact holes 132 and the two second contact holes 134 in the dielectric layer 130 respectively. Therefore, when any one of the scan line 110 or the data line 140 is faulty due to, for example, metal peeling, the signal may be still transmitted by the corresponding redundant line.

It is noted that, in general, there must be two contact holes formed in the dielectric layer 130 through which the scan line and the redundant scan line are electrically connected, or through which the data line and the redundant data line are electrically connected. Accordingly, two contact holes are required, and the diameter of the contact hole is about 3 mm to about 5 mm. However, if one of the contact holes is not successfully formed due to a faulty the process, the redundant line may not be used for repairing the scan line or the data line. Therefore, when any one of the contact hole is not successfully formed, the contact hole must be repaired by a laser repairing process to ensure that the contact hole is formed. However, the disadvantage of the laser repairing process is that the impedance of the repaired component is increased.

### SUMMARY OF INVENTION

Therefore, the present invention is directed to a pixel structure having at least three contact holes in the dielectric layer. Therefore, even though some of the contact holes are not successfully formed, the signal can be transmitted via the redundant scan line (or the redundant data line).

According to an embodiment of the present invention, a pixel structure having a contact window is provided. Therefore, even though some of the contact holes are not successfully formed, the signal can be transmitted via the redundant scan line (redundant data line).

In one embodiment of the present invention, a pixel structure suitable for disposing over a substrate is provided. The pixel structure comprises a scan line, a redundant scan line, a dielectric layer, a data line, an active component and a pixel electrode. The scan line is disposed over the substrate, and the redundant scan line is disposed over the scan line. The dielectric layer is disposed between the scan line and the redundant scan line, wherein the dielectric layer has at least three first contact holes through which the scan line and the redundant scan line can be electrically connected. The data line is disposed over the substrate, and the active component is disposed adjacent to the intersection of the scan line and the data line. The pixel electrode is electrically connected to the active component. The active component is controlled by the scan line to write an image signal transmitted by the data line to the pixel electrode.

In one embodiment of the present invention, a redundant data line is further disposed under the data line, wherein the dielectric layer is disposed between the data line and the redundant data line, and the dielectric layer has at least three second contact holes through which the data line and the redundant data line can be electrically connected via a conductive plug.

In one embodiment of the present invention, a redundant data line is further disposed under the data line, wherein the dielectric layer is disposed between the data line and the redundant data line, and the dielectric layer has a third contact hole having a size in a range of about 20 um to about a length of the data line through which the data line is electrically connected with the redundant data line.

In addition, the third contact hole comprises, for example but not limited to, a rectangular hole.

In one embodiment of the present invention, the active component comprises, for example but not limited to, a thin film transistor (TFT).

In one embodiment of the present invention, a first contact hole is further disposed over the dielectric layer between the scan line and the redundant scan line. The size of the first contact hole is about 20 um and about a length of the scan line through which the scan line is electrically connected with the redundant scan line. In addition, the first contact hole comprises, for example but not limited to, a rectangular hole.

In addition, the present invention provides a pixel structure suitable for disposing over a substrate. The pixel structure comprises, for example but not limited to, a scan line, a data line, a redundant data line, a dielectric layer, an active component and a pixel electrode. The scan line is disposed over the substrate, and the data line is disposed over the substrate. The redundant data line is disposed under the data line. The dielectric layer is disposed between the data line and the redundant data line, wherein the dielectric layer has at least three first contact holes through which the data line is electrically connected with the redundant data line. The active component is disposed adjacent to the intersection of the scan line and the data line. The pixel electrode is electrically connected to the active component, wherein the active component is controlled by the scan line to write the image signal transmitted by the data line to the pixel electrode.

In one embodiment of the present invention, the active component comprises, for example but not limited to, a thin film transistor (TFT).

In one embodiment of the present invention, a first contact hole is further disposed over the dielectric layer between the data line and the redundant data line. The size of the first contact hole is about 20 um and about the length of the data line for electrically connecting the data line and the redundant data line. In addition, the first contact hole comprises, for example but not limited to, a rectangular hole.

In one embodiment of the present invention, at least three contact holes or a line shaped contact hole having a size in a range of about 20 um to about the length of the scan line (data line) is formed over the dielectric layer between the scan line (data line) and the redundant scan line (redundant data line). Therefore, the scan line (data line) and the redundant scan line (redundant data line) may be electrically connected. Since the contact hole has a shape of a line or comprises at least three contact holes over the dielectric layer, even though some of the contact holes are not successfully formed, the signal may be transmitted via the redundant scan line (redundant data line).

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 is a top view schematically illustrating a conventional pixel structure with a redundant line.

FIG. 2 is a lateral cross-sectional view taken along the line A-A of FIG. 1.

FIG. 3 is a lateral cross-sectional view taken along the line B-B of FIG. 1.

FIG. 4 is a top view schematically illustrating a pixel structure with redundant line according to one embodiment of the present invention.

FIG. 5 is a lateral cross-sectional view taken along the line C-C of FIG. 4.

FIG. 6 is a lateral cross-sectional view taken along the line D-D of FIG. 4.

FIG. 7 is a top view schematically illustrating a pixel structure with redundant line according to one embodiment of the present invention.

FIG. 8 is a lateral cross-sectional view taken along the line E-E of FIG. 7.

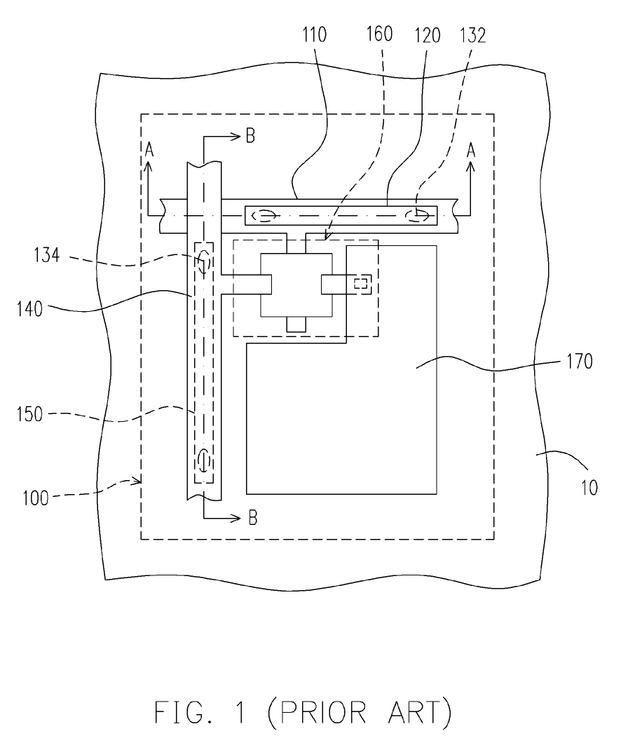

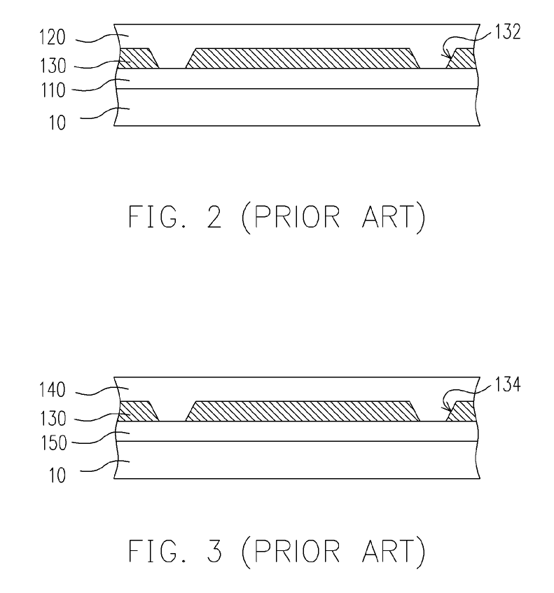

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

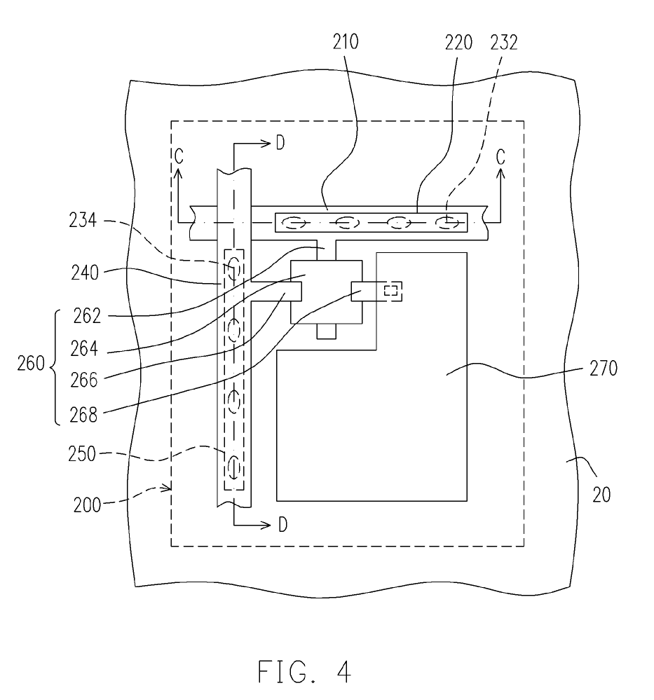

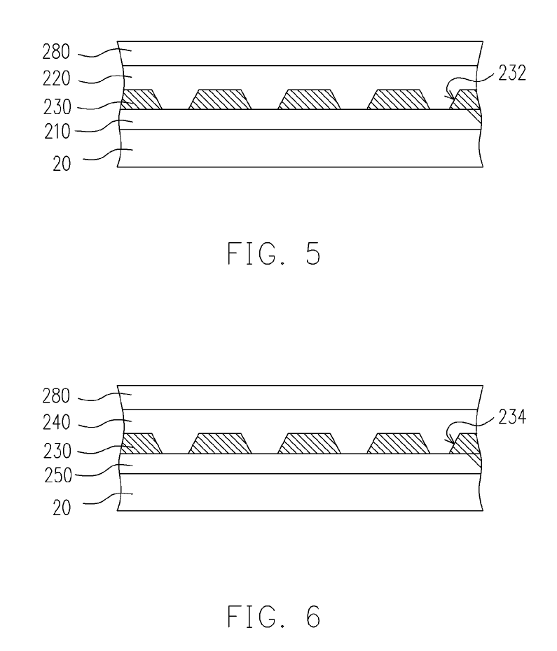

FIG. 4 is a top view schematically illustrating a pixel structure with redundant line according to one embodiment of the present invention. FIG. 5 is a lateral cross-sectional view according to line C-C of FIG. 4. FIG. 6 is a lateral cross-sectional view according to line D-D of FIG. 4. Referring to FIG. 4, FIG. 5 and FIG. 6, the pixel structure 200 of the present invention is disposed over a substrate 20. The pixel structure 200 is comprised of, for example but not limited to, a scan line 210, a redundant scan line 220, a dielectric layer 230, a data line 240, a redundant data line 250, an active component 260 and a pixel electrode 270.

The scan line 210 and the data line 240 are disposed over the substrate 20, the redundant scan line 220 is disposed over the scan line 210, and the redundant data line 250 is disposed under the data line 240. The dielectric layer 230 is disposed between the scan line 210 and the redundant scan line 220, and between the data line 240 and the redundant data line 250. At least three first contact holes 232 (there are four holes shown in the figures) are formed in dielectric layer 230 between the scan line 210 and the redundant scan line 220 to electrically connect the scan line 210 and redundant scan line 220. In addition, at least three second contact holes 234 (there are four holes shown in the figures) are formed in the dielectric layer 230 between the data line 240 and the redundant data line 250 to electrically connect the data line 240 and the redundant data line 250.

The active component 260 is composed of, for example but not limited to, thin film transistor (TFT). The active component 260 is disposed adjacent to the intersection of the scan line 210 and the data line 240. The active component 260 is comprised of, for example but not limited to, a gate 262, a channel layer 264, a source 266 and a drain 268. The gate 262 is connected to the scan line 210 and covered by the channel layer 264. The source 266 and the drain 268 are disposed over the channel layer 264 and on both sides of the gate 214, wherein the source 266 is connected to the data line 240.

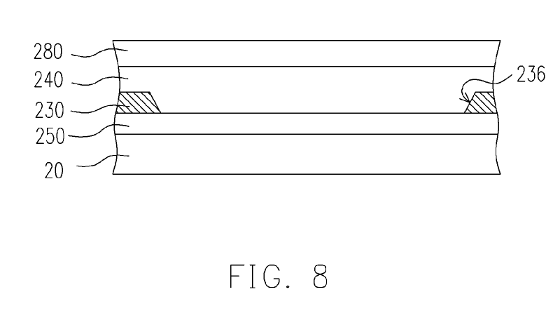

The pixel electrode 270 is electrically connected to the active component 260. At least a protection layer 280 is disposed over, for example but not limited to, the scan line 210, the data line 240 and the active component 260 (as shown in FIG. 8). An opening (not shown) is formed in the protection layer 280 corresponding to the drain 268 to electrically connect the pixel electrode 270 and the active component 260. Therefore, the active component 260 is controlled by the scan line 210 to write image signal transmitted by the data line 240 to the pixel electrode 170. Therefore, when an applicable voltage is applied to the gate 262, the channel layer 264 is conducted, and at this moment the image signal of the frame is written to the pixel electrode 280 via the data line 240, the source 266, the channel layer 264, and the drain 268.

It is noted that, in the present embodiment, the number of the first contact holes 232 and the number of the second contact holes 234 in the dielectric layer 230 are equal to or larger than three. However, the number of the contact holes formed in the conventional technology is two. Therefore, according to an embodiment of the present invention, when the contact holes are formed by patterning the dielectric layer 230, if anyone of the contact hole is not successfully formed due to a faulty process, the scan line 210 (or the data line 240) may also be electrically connected the corresponding redundant line through another successfully formed contact hole. Therefore, the redundant line may still work even when some of the contact holes are not successfully formed. In other words, if one of the contact holes are not successfully formed, the laser repairing process is not required to repair the contact holes. Thus, the problem of impedance increase due to laser repairing in the conventional technology does not occur in the present invention.

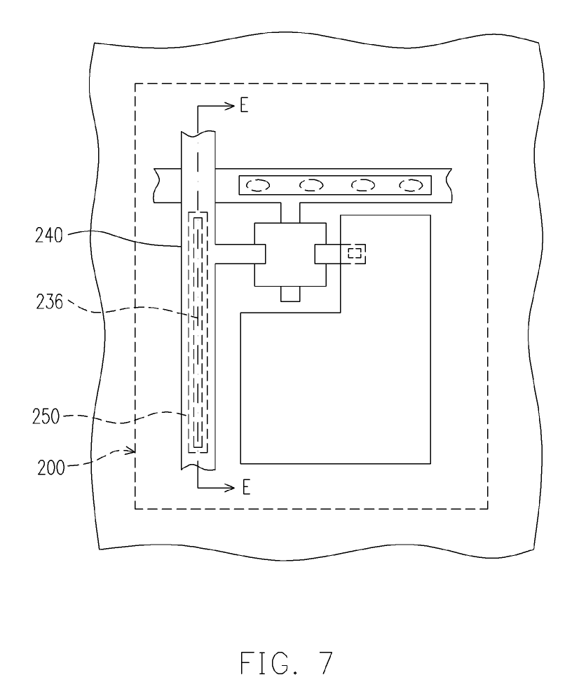

FIG. 7 is a top view schematically illustrating a pixel structure with redundant line according to one embodiment of the present invention. FIG. 8 is a lateral cross-sectional view taken along the line E-E of FIG. 7. The difference between the pixel electrode 200 of the embodiment described in FIGS. 7-8 and the embodiments described in FIGS. 4-6 is that a third contact hole 236 is disposed over the dielectric layer 230 between the data line 240 and the redundant data line 250 instead of the second contact holes. The size of the third contact hole 236 is in a range of about 20 um to about the length of the data line 240. Therefore, the data line 240 and the redundant data line 250 are electrically connected by the third contact hole 236. The third contact hole 236 is, for example but not limited to, rectangular or other shapes.

Since the third contact hole 236 comprises only one line shape contact hole, the faulty redundant line due to the faulty contact holes in the embodiments described above can be avoid.

Accordingly, in anther embodiment of the invention, the methods of forming at least three contact holes and forming a line shape contact hole may be incorporated in the dielectric layer between the scan line and the redundant scan line, and between the data line and the redundant data line. In other words, a line shape contact hole may also be formed in the dielectric layer between the scan line and the redundant scan line. In addition, at least three contact holes or a line shape contact hole may also be formed in the dielectric layer between the data line and the redundant data line. Moreover, in one embodiment of the invention, only the redundant scan line or the redundant data line of the pixel structure is required to be disposed over the scan line or the data line. Therefore, if the redundant scan line is not disposed over the scan line, the contact holes of the dielectric layer above the scan line may be omitted. In addition, if the redundant data line is not disposed under the under the data line, the contact holes of the dielectric layer under the data line may also be omitted.

Accordingly, in the pixel structure of the invention, at least three contact holes is formed in the dielectric layer between the scan line (data line) and the redundant scan line (redundant data line), or a line shape contact hole with a size in a range of about 20 um to about the length of the scan line (data line) is formed. Therefore, the scan line (data line) and the redundant scan line (redundant data line) may be electrically connected. Since the contact holes in the dielectric layer comprises at least three holes, or since the contact hole in a shape of a line, the problem of faulty redundant line due to faulty contact hole may be prevented. Therefore, the present invention can ensure the signal transmission of the scan line or the data line.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A pixel structure, comprising:
a scan line, disposed over a substrate;
a redundant scan line, disposed over the scan line;
a dielectric layer, disposed between the scan line and the redundant scan line, wherein at least three first contact holes are formed in the dielectric layer through which the scan line is electrically connected with the redundant scan line;
a data line, disposed over the substrate;
an active component, disposed adjacent to an intersection of the scan line and the data line; and
a pixel electrode, electrically connected to the active component, wherein the active component is controlled by the scan line to write an image signal transmitted by the data line to the pixel electrode.

2. The pixel structure of claim 1, further comprising:
a redundant data line, disposed under the data line, wherein the dielectric layer is disposed between the data line and the redundant data line, and the dielectric layer further has at least three second contact holes through which the data line is electrically connected with the redundant data line.

3. The pixel structure of claim 1, further comprising:
a redundant data line, disposed under the data line, wherein the dielectric layer is disposed between the data line and the redundant data line, and a third contact hole having a size in a range of about 20 um to about a length of the data line is formed in the dielectric layer through which the data line is electrically connected with the redundant data line.

4. The pixel structure of claim 3, wherein the third contact hole comprises a rectangular hole, and a length of the rectangular hole is in a range of about 20 um to about a length of the data line.

5. The pixel structure of claim 3, wherein the active component comprises a thin film transistor (TFT).

6. A pixel structure, comprising:
a scan line, disposed over a substrate;
a redundant scan line, disposed over the scan line;
a dielectric layer, disposed between the scan line and the redundant scan line, wherein a first contact hole having a size in a range of about 20 um to about a length of the scan line is formed in the dielectric layer through which the scan line is electrically connected with the redundant scan line;
a data line, disposed over the substrate;
an active component, disposed adjacent to an intersection of the scan line and the data line; and
a pixel electrode, electrically connected to the active component, wherein the active component is controlled by the scan line control to write an image signal transmitted by the data line to the pixel electrode.

7. The pixel structure of claim 6, wherein the first contact hole comprises a rectangular hole having a length in a range of about 20 um to about a length of the scan line.

8. The pixel structure of claim 6, further comprising:
a redundant data line, disposed under the data line, wherein the dielectric layer is disposed between the data line and the redundant data line, and at least three second contact holes are formed in the dielectric layer through which the data line is electrically connected with the redundant data line.

9. The pixel structure of claim 6, further comprising:
a redundant data line, disposed under the data line, wherein the dielectric layer is disposed between the data line and the redundant data line between, and a third contact hole having a size in a range of about 20 um to about a length of the data line through which the dielectric layer the data line is electrically connected with the redundant data line.

10. The pixel structure of claim 9, wherein the third contact hole comprises a rectangular hole having a length in a range of about 20 um to about a length of the data line.

11. The pixel structure of claim 6, wherein the active component comprises a thin film transistor (TFT).

12. A pixel structure, comprising:
a scan line, disposed over a substrate;
a data line, disposed over the substrate;
a redundant data line, disposed under the data line;
a dielectric layer, disposed between the data line and the redundant data line, wherein at least three first contact holes are formed in the dielectric layer through which the data line is electrically connected with the redundant data line;
an active component, disposed adjacent to an intersection of the scan line and the data line; and
a pixel electrode, electrically connected to the active component, wherein the active component is controlled by the scan line to write an image signal transmitted by the data line to the pixel electrode.

13. The pixel structure of claim 12, wherein the active component comprises a thin film transistor (TFT).

14. A pixel structure, comprising:
a scan line, disposed over a substrate;
a data line, disposed over the substrate;
a redundant data line, disposed under the data line;
a dielectric layer, disposed between the data line and the redundant data line, wherein a first contact hole having a size in a range of about 20 um to about a length of the data line is formed in the dielectric layer through which the data line is electrically connected with the redundant data line;
an active component, disposed adjacent to an intersection of the scan line and the data line; and
a pixel electrode, electrically connected to the active component, wherein the active component is controlled by the scan line control to write an image signal transmitted by the data line to the pixel electrode.

15. The pixel structure of claim 14, wherein the first contact hole comprises a rectangular hole having a length in a range of about 20 um to about a length of the data line.

16. The pixel structure of claim 14, wherein the active component comprises a thin film transistor (TFT).
